(19) United States
(12) Patent Application Publication
(10) Pub. No.: US 2002/0133261 A1
(43) Pub. Date: Sep. 19, 2002

(54) Method and system for producing garments having a vintage appearance

(76) Inventor: Keyomars Fard, Redondo Beach, CA (US)

Correspondence Address: JENKENS & GILCHRIST, PC, 1445 ROSS AVENUE, SUITE 3200, DALLAS, TX, 75202, US

(21) Appl. No.: 10/064,059

(22) Filed: Jun. 5, 2002

(51) Int. Cl. G06F 19/00

(52) U.S. Cl. 700/131; 700/132

(57) ABSTRACT

A garment having a vintage appearance is produced by method including forming panel(s) of fabric. A pattern using chemical(s) is printed on the panel(s). The garment having a vintage appearance is constructed utilizing the panel(s) having the chemical (s) printed thereon.

### BACKGROUND OF INVENTION

1. Field of the Invention

The principles of the present invention generally relate to production of garments, and more particularly, but not by way of limitation, to a method and system for producing garments having a used appearance.

2. Description of Related Arts

Production of vintage garments designed by apparel designers, however, is not trivial. Traditionally, techniques for producing vintage garments include subjecting the garment (e.g., pair of jeans) to localized abrasion processes, such as sanding with sandpaper, sandblasting, and/or using a grinding wheel. Using such techniques demand that the production worker be somewhat of an artist to create a vintage garment having a natural look and feel. The sanding process is generally performed manually and may take five to fifty minutes per garment depending on the quality desired and the skill of the production worker. Even an expert may find it difficult to consistently produce a high-quality vintage garment. Other techniques used to produce vintage garments may include the manual use of equipment that outputs electricity, chemicals, or amplified light. Even using these equipment driven techniques, however, the resulting garments may have a tendency to look processed rather than natural.

In a consuming economy, consumer demand drives the number of garments to be produced. Because of the popularity of vintage garments, a typical vintage garment produced may be in excess of 100,000 garments per week, thereby requiring many hundreds of production workers to meet production demand of the vintage garments. Each of the production workers, of course, requires training and practice to produce the vintage garments. Labor costs for such production efforts becomes very expensive and produceability and repeatability of the vintage garments is a challenge.

To improve produceablity and repeatability of the vintage garments, at least one manufacturer has suggested performing the manual procedures on panels or individual cut pieces of the garment prior to construction of the garment. However, because the panels have no defined border regions, a computer imaging system has been used to assist the production worker with locating positions on the panels to manually apply the mechanical or chemical processes. Because the computer imaging process merely aids the manual process, production costs are not substantially reduced and quality is not significantly improved as some level of artistry to produce an aesthetically pleasing garment is still required of the production worker.

### SUMMARY OF INVENTION

To overcome the repeatability, produceability, and cost problems of manufacturing vintage garments (e.g., garments appearing to have been used or worn for a period of time), a printing process may be employed for manufacturing the vintage garments. The printing process may be utilized to remove color, inhibit color removal, and/or inhibit color penetration, for example, on panels of fabric prior to being constructed into the garment. By utilizing a printing process, produceability, repeatability, and cost of production may be improved.

In one embodiment, a garment having a vintage appearance is produced by method including forming panel(s) of fabric. A pattern using chemical(s) is printed on the panel(s). The garment having a vintage appearance is constructed utilizing the panel(s) having the chemical(s) printed thereon.

### BRIEF DESCRIPTION OF DRAWINGS

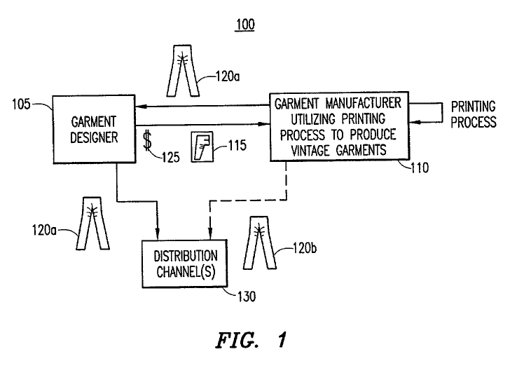

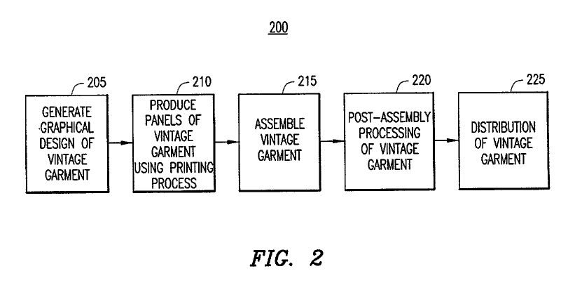

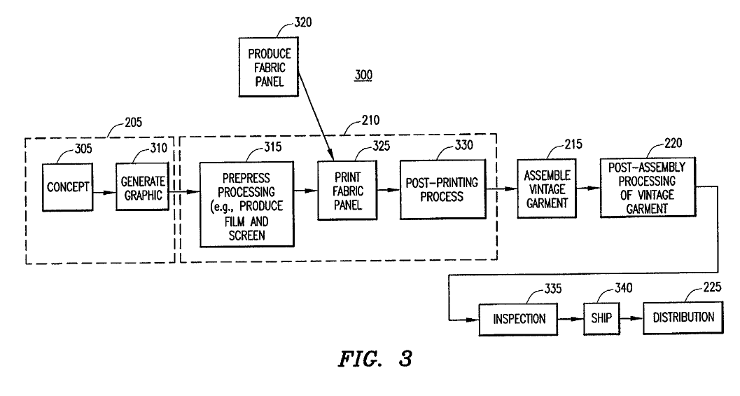

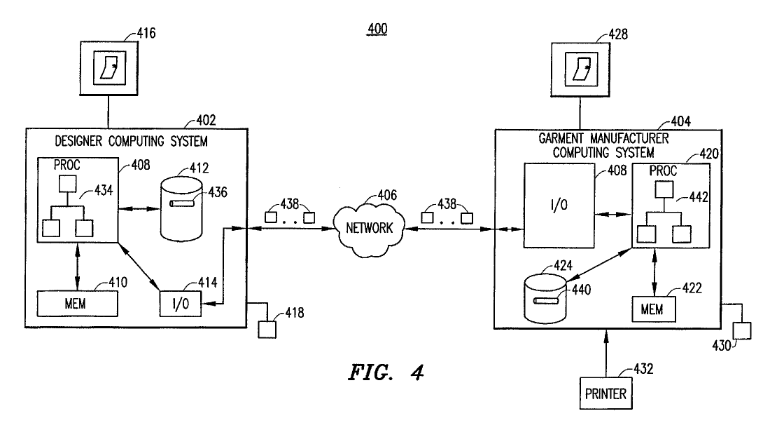

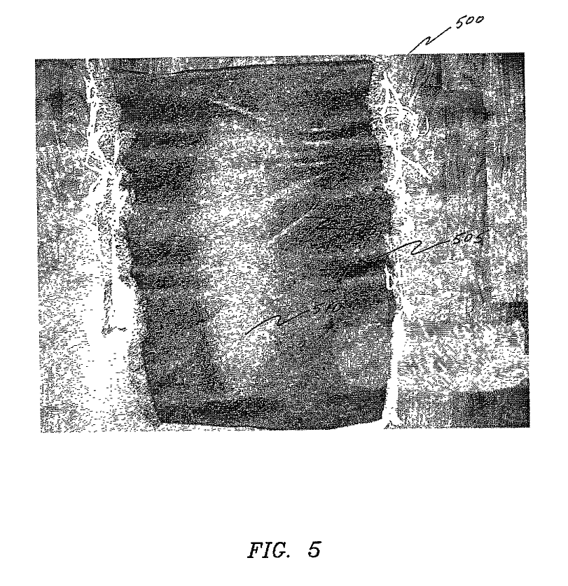

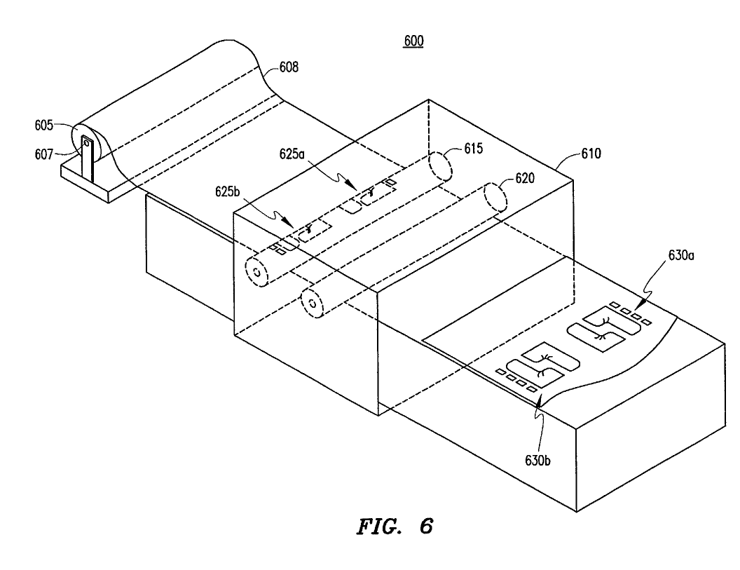

A more complete understanding of the method and apparatus of the principles of the present invention may be obtained by reference to the following Detailed Description when taken in conjunction with the accompanying Drawings wherein: FIG. 1 is an exemplary block diagram showing interaction between a garment designer and a garment manufacturer utilizing a printing process according to the principles of the present invention; FIG. 2 is an exemplary flow diagram indicative of a method of manufacturing vintage garments by the garment manufacturer of FIG. 1; FIG. 3 is a more detailed flow diagram of the production process of FIG. 2 for producing the vintage garments; FIG. 4 is an exemplary block diagram of computing systems operating on a network for communicating information to be utilized in the production process of the vintage garments between the garment designer and garment manufacturer of FIG. 1; FIG. 5 is a photograph of an exemplary panel of a vintage garment produced in accordance with the principles of the present invention according to FIGS. 2-5; and FIG. 6 is another embodiment for producing vintage garments utilizing a continuous printing process according to the principles of the present invention.

### DETAILED DESCRIPTION

The principles of the present invention will now be described more fully hereinafter with reference to the accompanying drawings, in which embodiments of the principles of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Manufacturing vintage garments (e.g., garments having a used, worn, weathered, creased, whiskered, and/or faded appearance) has traditionally been performed using hand-processing techniques on fully constructed garments, such as jeans. The garments, however, may also include pants, shirt, jacket, hat, and socks, for example. The hand-processing may include using sandpaper, sanding machines, sand blasting machines, machines that produce electrical arcing, chemicals, amplified light, and lasers, for example. As well understood in the art, hand processing to produce vintage garments is difficult in terms of produceability, repeatability, and cost effectiveness.

The principles of the present invention provide for a printing process to be utilized to instantly age panels of fabric to appear as a vintage garment. A panel may be a piece of fabric that is or is not pre-cut in the shape of a portion of a garment. A designer may generate and provide a graphical representation of a vintage garment to a garment manufacturer that utilizes the printing process. One reason that the printing process may have less of a processed look is that gray-scale techniques may be utilized to smooth edges of faded areas. From the graphical representation, the garment manufacturer may generate a screen or other element to be utilized for the printing process using traditional printing press techniques known in the art. Such printing press techniques may include the use of pressing, rolling, screening, and stamping, for example, and utilize plates or other contacting devices as understood in the art. The printing process may be performed on individual panels of fabric prior to construction of the garment, and be utilized to apply one or more chemicals to remove color, inhibit color removal, and/or inhibit color penetration on the panels. The panels may thereafter be constructed into the vintage garment.

FIG. 1 is an exemplary block diagram 100 showing interaction between a garment designer 105 and garment manufacturer 110, utilizing a printing process according to the principles of the present invention. The garment designer 105 may be any designer of garments interested in designing, producing, and/or selling vintage garments. The garment manufacturer 110 is a manufacturer that may coordinate or conduct the cutting, sewing, dry or wet processing (i.e., altering appearance of the garment), and final finishing of the garment intended for sale to a designer, distributor, or retailer.

The garment designer 105 may generate a graphical representation 115 of one or more panels of a vintage garment. The garment manufacturer 110 utilizes a printing process on the panels to produce the vintage garment based on the graphic provided by the garment designer 105 or garment manufacturer 110. After the garment manufacturer 110 produces the vintage garments 120a and/or 120b (collectively 120), the garment manufacturer 110 may deliver the vintage garments 120a to the garment designer 105 for inspection and/or distribution of the vintage garment 120a. After acceptance of the vintage garments 120a, the garment designer may tender payment 125 for the vintage garments 120a to the garment manufacturer 110 via cash, check, charge, credit, and/or electronic communication. The garment designer 105 may then distribute the vintage garments 120a to a distribution channel 130, where the distribution channel may include wholesale, retail, and Internet locations, for example. Additionally and/or alternatively, the garment manufacturer 110 may perform a “drop ship” of the vintage garments 120b to the distribution channel 130 as specified by the garment designer 105.

FIG. 2 is an exemplary flow diagram indicative of a method of manufacturing vintage garments 120 by the garment manufacturer of FIG. 1. At 205, a graphical design 115 of the vintage garment 120 is generated. The graphical design 115 may include a design of an individual panel, multiple panels, and/or the complete vintage garment 120. At 210, panels of the vintage garment 120 may be produced using a printing process by the garment manufacturer 110. At 215, the vintage garment is assembled by the garment manufacturer, where the assembly may include sewing the panels of the vintage garment 120 together to form the vintage garment 120. At 220, post-assembly processing of the vintage garment 120 may be performed. The vintage garment 120 may be distributed at 225 by the distribution channel 130.

FIG. 3 is a more detailed flow diagram 300 of the production process of FIG. 2 for producing the vintage garments 120. The generation of the graphical design 115 of the vintage garment 120 of step 205 may be expanded to include concept 305 and generation 310 of the graphic 115. The concept 305 may include searching for an exiting vintage garment 120 (e.g., used pair of blue jeans), brainstorming to design an aesthetically pleasing graphical representation of a vintage garment, or any other thought process or technique utilized to conceive or envision what an aesthetically pleasing, consumer desirable vintage garment would look like.

At 310, the graphical design 115 may be generated. The generation 310 of the graphical design may include a number of traditional and digital techniques. Traditional techniques may include hand sketching, painting, and taking photographs of existing vintage garments, for example. Digital techniques for generating the graphical design 115 may include utilizing a graphical design software package on a computing system, scanning an image of a vintage garment 120, taking a digital photograph of an existing vintage garment 120, and digitally altering a digital image of a vintage garment 120, for example. It should be understood that any technique utilized to produce a graphical representation of a vintage garment may be utilized by the garment designer 105, garment manufacturer 110, or freelance designer (if utilized).

Vintage garments generally have two main coloration characteristics, fading and creasing. In the case of jeans, the front panels typically are faded on the thighs and have creases, generally known as “whisker lines” that form around the crotch area. The creases tend to be lighter than surrounding areas of the jeans. The creases are generally random and are shaped wide on one end, thin in the middle, and wide on the other end. If properly shaped and sized or dimensioned, a single graphical design may be utilized to produce multiple sizes of the vintage garment utilizing the printing process according to the principles of the present invention.

Step 210 for producing panels of the vintage garment 120 utilizing a printing process may include a number of steps. At step 315, pre-press processing utilizing the graphic design 115 of the vintage garment 120 generated at step 310 may be performed. The pre-press processing 315 may include producing film and screen(s) used in the printing process as understood in the art. Alternatively, digital press techniques that do not require film and screens may be utilized. At 320, individual fabric panels are produced. The individual fabric panels may be produced from either preshrunk fabric or unwashed fabric (i.e., not preshrunk), and may be cut into specific sizes and shapes to be utilized to construct the vintage garment 120. It should be understood that the graphic design 115 may have different dimensions depending upon whether the fabric utilized for the panels is or is not preshrunk.

At step 325, the fabric panels are printed using the screen produced by the pre-press processing 315. The printing process may include printing one or more panels simultaneously depending upon the size of the printing press as understood in the art. The printing process may additionally be manual, automatic, and semiautomatic as understood in the art.

In printing the panels, the panels being printed may be substantially centered with respect to the particular design so that a design wide enough to be utilized to print extra sized large garments may be used for small sized garments as well. By substantially centering the panels during printing, the chemicals may simply “bleed” off the edges of the small panels. This centering technique allows the producer to utilize one screen for multiple sizes of the vintage garment 120. And, as a typical garment may have as many as nine sizes, much time and money may be saved from not having to make multiple screens for each design and size of the vintage garment 120.

As understood in the art, the screens generally include escape holes of different sizes for chemical(s) to be applied to the fabric. The chemical(s) utilized may remove color, inhibit the removal of color, and/or inhibit color penetration (i.e., dyeability). It is generally understood that chemicals for removing color may be of two types, reductive and oxidative decoloration. Reductive decoloration chemicals are generally heat activated. Decoloration chemicals may include potassium permanganate, sodium hydrosulfite, sodium hypochlorite (i.e., bleach), or any other chemical having concentrations that may perform the function of decolorizing dyed fabric as understood in the art. For example, chemical concentrations of 0.1% to 10% may be utilized to decolorize the fabric. Chemicals utilized for either reductive or the oxidative decoloration may utilize concentrations of the active ingredients to perform the color removal process as understood in the art. It should be further understood that one or more chemicals may be printed on the panels of fabric. A combination of chemicals may be utilized to produce a chemical reaction to remove or inhibit removal of color from the fabric. In the case of using multiple chemicals to produce a chemical reaction, a single inactive chemical may be printed on the panel of fabric, and may be activated in a post-printing process by applying one or more additional chemicals to the panels or complete garment. To inhibit dyeability to the panel of fabric, resins that may be heat set or activated may be printed on the fabric to act as a mask so that the surface area covered by the mask is not affected by dying the panel of fabric. In other words, a negative image may be printed on the panel of fabric. The dye inhibitor may be printed on fabric so that applying a dye to the fabric during the post-printing process dyes the fabric in areas not dye inhibited.

At step 330, post-printing processing may be performed on the panels of fabric. The post-printing processing 330 may include heating the panels having the chemicals applied thereto in an oven or by another heating device.

At 215, the vintage garment 120 is assembled. The assembly may include coupling the panels of the vintage garment 120 together by use of a sewing process as understood in the art. At step 220, post-assembly processing of the vintage garment 120 may be performed. The post-assembly processing of the vintage garment 120 may include (i) applying heat to the garment to activate a chemical reaction, (ii) applying dye to the fabric of the vintage garment to further increase colorization of the fabric, and (iii) applying additional chemicals to the garment to cause a reaction of the printed chemicals or cause a decoloration of the fabric not printed by the printing process. Additionally, the post-assembly processing of the garment may include washing the complete garment, possibly using abrasives and/or chemicals. The post-assembly processing may include heating the garment with the applied chemicals (i.e., curing process) for 15 seconds to 15 minutes and/or washing the garment for 5 180 minutes. It should be understood that the curing and washing processes are varied based on the chemical applied, look desired, and finish sought. Alternatively, traditional manual processing to perform localized abrasion and/or chemical application may be further utilized to enhance the look of the printed panels of the vintage garment 120.

At step 335, an inspection may be performed to determine whether the quality of the vintage garment as specified has been met. At step 340, the vintage garment 120 may be shipped to the garment designer 105 or the distribution channel 130. At step 225, the vintage garment 120 may be distributed by the distribution channel 130.

FIG. 4 is an exemplary block diagram of computing systems operating on a network for communicating information of the vintage garments between the garment designer 105 and garment manufacturer 110. A garment designer computing system 402 may be in communication with a garment manufacturer computing system 404 via a network 406, such as the Internet. The garment designer computing system 402 may include a processor 408 coupled to a memory 410 and storage device 412. A processor 408 may further be coupled to an input/output device 414. The garment designer computing system 402 is further coupled to a display 416 and a control device 418, such as computer mouse.

The garment manufacturer computing system 404 may similarly include a processor 420 coupled to a memory 422, storage device 424, and I/O device 426. A display 428 and control device 430 may additionally be coupled to the garment manufacturer computing system 404. A printer 432 for printing either paper or film may additionally be coupled to the garment manufacturer computing system 404.

In operation, the garment designer 105 may utilize the garment designer computing system 402 to design the vintage garments 120. A processor 408 may execute a software program 434 to design the vintage garment 120. In general, the software program 434 is a graphics oriented program for designing the graphic design 115 representative of the vintage garment 120 or a portion (e.g., panel) thereof. One graphics oriented program that may be utilized is Adobe Photoshop®. A database 436 stored on the storage device 412 may be utilized to maintain the graphic designs 120 for different designs of the vintage garments 120. An input device (not shown), such as a scanner or digital camera, may additionally be coupled to the designer computing system 402 for scanning or loading an image of a vintage garment 120.

Although the garment designer 105 may output the graphic design 115 of the vintage garment 120 onto a tangible media, such as paper or film, a digital representation of the graphic design 115 may be communicated from the garment designer computing system 402 to the garment manufacturer computing system 404 via the network 406 in data packets 438 as understood in the art. In other words, the graphic design 115 may be delivered to the garment manufacturer 110 via a tangible medium or electronically, such as by an e-mail or remote access. If delivered electronically, the garment manufacturer computing system 404 may receive the data packets 438 containing information representative of the graphic design 115 of the vintage garment 120, and store the information in a database 440 on the storage device 424.

Rather than the garment designer 105 designing the vintage garment 105 using the garment designer computing system 402, the garment designer 105 may work with an employee or independent contractor of the garment manufacturer 110 using the garment manufacturer computing system 404. It should be understood that independent of the computer system or location that the graphic design 115 is developed, that the output of such a joint effort to design the vintage garment 120 constitutes a delivery of the graphic design 115. Upon completion of the design, the graphic design 115 may be printed onto paper or film via the printer 432. As understood in the art, the output may be utilized to produce a screen for the printing process to produce panels of fabric having the vintage design printed thereon. It should be understood that multiple screens having different patterns (e.g., faded area and whisker lines) may be utilized to produce the vintage garment 120. Additionally, if a digital printing process is utilized (i.e., a printing process that does not utilize screens), then the delivery of the graphic design 115 may be simply the transmission or delivery of the computer file.

FIG. 5 is an exemplary photograph 500 of a panel 505 of a vintage garment 115. As shown, the panel 505 includes two general patterns, a faded area 510 and creases or whisker lines 515. By printing directly on the panel 505, the garment manufacturer 110 may control quality and repeatability of the design produced by the garment designer 105. Designs may change without having to retrain the production workers. Additionally, labor costs may be substantially reduced as a substantial amount of hand-processing for producing the vintage garment 120 may be eliminated.

FIG. 6 is an illustration 600 of an exemplary continuous printing process for producing vintage garments according to the principles of the present invention. As shown, a bolt 605 of fabric 608, which may or may not be predyed based on the vintage garments being produced, is mounted to a roller 607. A continuous printer 610, such as a web printer as understood in the art, continuously prints on the fabric 608 using one or more print rollers 615 and 620. A mask or plate coupled to the roller(s) 615 and 620 containing patterns 625a and 625b (collectively 625) representing the design of the vintage appearance to be printed on the fabric continuously rolls across the fabric 608 to print the chemicals to alter the appearance of the fabric 608 as understood in the art. The resulting print patterns 630a and 630b (collectively 630) on the fabric 608 may include an outline of panels and design to be configured into a vintage garment 120.

Additionally or alternatively, the resulting print pattern may include cut or registration marks (not shown) for the manufacturer to utilize in aligning, cutting, and/or fabricating the vintage garment 120. The registration marks may be printed using ink or chemical. In one embodiment, the manufacturer may cut individual panels for fabrication of the vintage garment 120. Alternatively, to save production costs, multiple sections (e.g., 100 sections) of the fabric 608 may be stacked and cut such that multiple panels may be cut simultaneously. To align the sections for simultaneous cutting, the cut marks or other registration identifier may be aligned manually or automatically. In one embodiment, each section of panels or page may be cut to substantially the same size and aligned accordingly so that cutting the panels or print patterns 630 via registration marks or using a traditional cutting technique (e.g., paper outline) may be utilized. Vintage garments 120 may thereafter be fabricated and processed as discussed hereinabove and as understood in the art.

The previous description is of an embodiment for implementing the principles of the present invention, and the scope of the invention should not necessarily be limited by this description. The scope of the present invention is instead defined by the following claims.

1. A method for manufacturing garments having a vintage appearance, said method comprising:
forming a plurality of panels of fabric of a garment;
printing a pattern using a chemical on at least one panel of fabric, the chemical being utilized to produce the garment with the vintage appearance; and
constructing the garment utilizing the plurality of panels, the plurality of panels including the at least one chemical printed panel.

2. The method according to claim 1, wherein the garment includes at least one of the following: pants, shirt, and jacket.

3. The method according to claim 1, wherein the chemical includes a color remover.

4. The method according to claim 1, wherein the chemical includes a color remover inhibitor.

5. The method according to claim 1, wherein the chemical includes a color penetration inhibitor.

6. The method according to claim 1, wherein said printing is performed on an individual panel basis.

7. The method according to claim 1, wherein the plurality of panels of fabric are pre-dyed.

8. The method according to claim 1, wherein the vintage appearance includes at least one of the following: faded, weathered, used, worn, and whiskered.

9. The method according to claim 1, wherein the chemical includes at least one of the plurality of chemicals operable to produce a reaction to remove color from the fabric.

10. The method according to claim 1, further comprising post-processing the constructed garment to alter the fabric.

11. The method according to claim 8, wherein said post-processing includes at least one of sanding and washing the fabric.

12. The method according to claim 1, further comprising producing at least one screen utilized by said printing of the chemical.

13. The method according to claim 1, further comprising designing a graphical representation of the vintage garment.

14. The method according to claim 1, further comprising heating the at least one panel having the chemical printed thereon to induce a chemical reaction.

15. A system for manufacturing garments having a vintage appearance, said system comprising:
means for forming a plurality of panels of fabric of a garment;
means for printing a pattern using a chemical on at least one of the panels of fabric, the chemical being utilized to produce the garment with the vintage appearance; and
means for constructing the garments utilizing the plurality of panels, the plurality of panels including the at least one chemically printed panel.

16. The method according to claim 13, further comprising means for postthe constructed garment to alter the fabric.

17. The method according to claim 13, further comprising means for designing a graphical representation of the vintage garment.

18. A method for manufacturing a garment having a used appearance, said method comprising:
receiving a garment panel prior to being assembled into the garment;
printing a chemical in a predetermined pattern on the garment panel, the chemical operable to alter coloration of the garment panel; and
assembling the garment with at least one printed garment panel.

19. The method according to claim 18, wherein the chemical includes a color remover.

20. The method according to claim 18, wherein the chemical includes a color remover inhibitor.

21. The method according to claim 18, wherein the chemical includes a color penetration inhibitor.

22. The method according to claim 18, wherein the used appearance includes at least one of the following: fading, weathering, wearing, and whispering.

23. The method according to claim 18, wherein the chemical includes at least one of a plurality of chemicals operable to produce a reaction to remove color from the garment panel.

24. The method according to claim 18, further comprising utilizing a post-printing process on the garment to alter the coloration of the garment panel.

25. The method according to claim 18, further comprising receiving a graphical design of the used appearance to substantially replicate in said printing.

26. A system for manufacturing a garment having a used appearance, said method comprising:
means for receiving a garment panel prior to being assembled into the garment;
means for printing a chemical in a predetermined pattern on the garment panel, the chemical operable to alter coloration of the garment panel; and
means for assembling the garment with at least one printed garment panel.

27. A system for producing a garment having a used appearance, said system comprising:
a printing press configured to print a chemical on fabric to produce a predetermined pattern indicative of the used appearance.

28. The system according to claim 27, wherein said printing press utilizes a plate to print the chemical.

29. The system according to claim 27, wherein said printing press utilizes a roller to print the chemical.

30. The system according to claim 27, wherein said printing press utilizes a screen to print the chemical.

31. The system according to claim 27, wherein the chemical includes a color remover.

32. The system according to claim 27, wherein the chemical includes at least one of a color remover inhibitor and color penetration inhibitor.

33. The system according to claim 27, further comprising a heat producer operable to cure the chemical.

34. The system according to claim 27, further comprising a washing machine operable to rinse the chemical from the fabric.

35. A method for procuring garments having a used appearance, said method comprising:
generating a graphical representation illustrative of at least one panel of a garment having the used appearance;
providing the graphical representation to a manufacturer of garments for producing the garment defined by the graphical representation using a chemical printing process; and
tendering payment for production of the garment.

36. The method according to claim 35, wherein the chemical printing process includes screen printing.

37. The method according to claim 35, wherein the chemical printing process includes pressing.

38. The method according to claim 35, wherein the chemical printing process includes rolling.

39. The method according to claim 35, wherein the chemical printing process includes screen printing.

40. The method according to claim 35, wherein the graphical representation is stored on at least one of an electronic and non-electronic medium.

41. The method according to claim 35, wherein the garment includes at least one of the following: pants, shirt, jacket, hat, and socks.

42. The method according to claim 35, wherein the graphical representation is at least one of a positive and negative representation.

43. The method according to claim 35, wherein said generating includes at least one of the following: drawing, photographing, and illustrating.

44. The method according to claim 35, further comprising distributing the vintage garments.

45. The method according to claim 35, wherein the graphical representation is operable to be utilized for multiple sizes of the vintage garment.

46. A system for procuring garments having a used appearance, said system comprising:
means for generating a graphical representation illustrative of at least one panel of a garment having a used appearance;
means for providing the graphical representation to a manufacturer of garments for producing the garment defined by the graphical representation using a chemical printing process; and
means for tendering payment for production of the garment.

47. A method for designing a vintage garment, said method comprising:
generating a graphical representation of at least one panel of a garment having a used appearance, the graphical representation having dimensions operable to be utilized in producing at least one garment size by the graphical representation, and a derivative of the graphical representation being utilized on a printer to print a chemical on the at least one panel of the garment.

48. The method according to claim 47, wherein the graphical representation is stored on an electronic or non-electronic medium.

49. The method according to claim 47, wherein the graphical representation is produced by a photograph for an existing garment.

50. The method according to claim 47, wherein the generating of the graphical representation includes producing at least one of a positive or negative representation of the used appearance.

51. The method according to claim 37, wherein the used appearance includes at least one of the following characteristics: worn, faded, weathered, creased, and whiskered.

52. A system for designing a vintage garment, said system comprising:
means for generating a graphical representation of at least one panel of a garment having a vintage appearance, the graphical representation having dimensions operable to be utilized in producing at least one garment size by the graphical representation, and a derivative of the graphical representation being utilized on a printer to print a chemical on the at least one panel of the garment; and
means for outputting the graphical representation onto a tangible medium.

53. A system for procuring a vintage garment, said system comprising:
a computing system including a processor coupled to a storage device, the computing system further coupled to a control device and display, the processor executing software operable by an operator utilizing the control device and display to generate a graphical representation of at least one panel of a garment having a vintage appearance and print the graphical representation utilizing a printing process, the graphical representation being stored by the storage device.

54. The system according to claim 53, wherein the operator is a garment designer.

55. The system according to claim 53, wherein the control device is a computer mouse.

56. The system according to claim 53, further comprising an input device coupled to said computer system.

57. The system according to claim 56, wherein a said input device includes at least one of a digital camera and a scanner.

58. The system according to claim 53, wherein said computing system is coupled to a network for communicating the graphical representation to a second computing system operating on the network.

59. The system according to claim 58, wherein the network is the Internet.

60. The system according to claim 53, further comprising a database located on the storage device for storing the graphical representation.

61. A method for manufacturing fabric having a vintage appearance, said method comprising:
forming an element having a pattern of the vintage appearance, the element operable to be utilized in a printing process; and
printing a chemical on the fabric utilizing the element, the chemical being utilized to produce the fabric with the vintage appearance.

62. The method according to claim 61, wherein the element includes at least one of a plate and roller.

63. The method according to claim 61, wherein the element is a screen.

64. The method according to claim 61, further comprising forming the fabric having the vintage appearance into a garment.

65. The method according to claim 61, wherein the chemical includes at least one of the following: a color remover, color remover inhibitor, and color penetration inhibitor.

66. The method according to claim 61, wherein the printing process is a continuous printing process.

67. The method according to claim 61, further comprising cutting the fabric.

68. The method according to claim 67, further comprising printing and aligning registration marks.

69. A fabric formed by a method comprising:
forming an element having a pattern of the vintage appearance, the element operable to be utilized in a printing process; and
printing a chemical on the fabric utilizing the element, the chemical being utilized to produce the fabric with the vintage appearance.

70. The method according to claim 69, wherein the element includes at least one of a plate and roller.

71. The method according to claim 69, wherein the element is a screen.

72. The fabric according to claim 69, wherein the fabric includes a plurality of patterns having a vintage appearance being substantially the same.

73. A garment formed by a method comprising:
forming an element having a pattern of the vintage appearance, the element operable to be utilized in a printing process;
printing a chemical on the fabric utilizing the element, the chemical being utilized to produce the fabric with the vintage appearance;
cutting the fabric to form at least one panel; and
coupling the at least one panel.

74. The method according to claim 73, wherein the element includes at least one of a plate and roller.

75. The method according to claim 73, wherein the element is a screen.

76. The garment according to claim 73, further comprising:
printing at least one registration mark indicative of alignment locations.
